(19) United States
(12) Patent Application Publication
(10) Pub. No.: US 2026/0147350 A1
(43) Pub. Date: May 28, 2026

(54) METHOD OF CONTROLLING ROBOT BASED ON SIMPLIFIED MAP AND NATURAL-LANGUAGE COMMAND AND COMPUTER PROGRAM THEREFOR

(71) Applicant: MAUM.AI, INC., Gyeonggi-do (KR)

(72) Inventors: Su Hwan CHOI, Gyeonggi-do (KR); Myun Chul JOE, Gyeonggi-do (KR); Yong Jun CHO, Gyeonggi-do (KR); Yu Been PARK, Gyeonggi-do (KR)

(73) Assignee: MAUM.AI, INC., Gyeonggi-do (KR)

(21) Appl. No.: 19/421,291

(22) Filed: Dec. 16, 2025

Related U.S. Application Data
(63) Continuation of application No. PCT/KR2025/019681, filed on Nov. 25, 2025.

(30) Foreign Application Priority Data
Nov. 28, 2024 (KR) 10-2024-0173940

(51) Int. Cl. G05D 1/246; G05D 1/229; G05D 101/15; G06F 40/284; G06F 40/289; G06T 7/73

(52) U.S. Cl. CPC G05D 1/2469; G05D 1/229; G06F 40/284; G06F 40/289; G06T 7/74; G05D 2101/15; G06T 2207/20081; G06T 2207/30252

(57) ABSTRACT

An embodiment of the present disclosure provides a method of controlling a robot based on a simplified map and a natural-language command. The method may include acquiring an image of a space, acquiring a simplified map of the space, the simplified map including a current position of a robot and a destination position of the robot and not including at least some elements describing the space, acquiring a natural-language command specifying compliance requirements that the robot is to comply with during an operation of the robot, generating input tokens based on at least one of the image, the simplified map, and the natural-language command, and generating waypoint tokens by processing the input tokens with a trained vision-language-action model.

### CROSS-REFERENCE TO RELATED APPLICATIONS

The present application is a bypass continuation of PCT Application No. PCT/KR2025/019681 filed Nov. 25, 2025, entitled “Method of controlling robot based on simplified map and natural-language command and computer program thereof” under 35 U.S.C. § 365(c), which claims priority under 35 U.S.C. § 119 to Korean Patent Application No. 10-2024-0173940, filed on Nov. 28, 2024, in the Korean Intellectual Property Office, the disclosure of which is incorporated by reference herein in its entirety.

### BACKGROUND

### 1. Technical Field

The present disclosure relates to a method of providing a user interface for controlling a robot based on a simplified map and a natural-language command.

### 2. Related Art

With the development of information and communication techniques, many applications have started to use artificial intelligence. In the field of robot control, there is also a trend toward actively using artificial intelligence, and accordingly, a trend toward replacing humans with artificial intelligence in robot control tasks has emerged.

In the related art, robots are implemented to automatically perform operations according to predefined rules. This approach, however, has clear limitations in that robots may not perform intended operations when exposed to environments for which applicable rules were not prepared.

Furthermore, in the related art, precise sensing data and correct commands are required for robot operations. This not only requires users to have a high level of understanding of robots, but also presents the issue that time-varying tasks cannot be easily reflected in robot operations.

### SUMMARY

To address the limitations and issues described above, the present disclosure seeks to control a robot based on a simplified map and a natural-language command. In addition, the present disclosure seeks to control a robot by setting compliance requirements in natural-language form, without separate rule-based coding. The present disclosure also seeks to enable a robot to make autonomous judgments and decisions in unexpected situations. The present disclosure further seeks to enable control of a robot even without precise sensing data regarding an environment in which the robot operates.

An embodiment of the present disclosure provides a method of providing a user interface for controlling a robot based on a simplified map and a natural-language command. The method may include: displaying a screen including a first interface and a second interface, wherein the first interface may be for displaying a simplified map of a space and a position of a robot and acquiring a first type of command from a user via the simplified map, and the second interface may be for acquiring a second type of command that the robot is to comply with during an operation of the robot; acquiring a user's input via at least one interface displayed on the screen; and displaying, on the screen, update information generated by the user's input and update information generated by the operation of the robot.

In various embodiments, the first type of command may include an input selected from drawing a destination point on the simplified map, drawing a route including the destination point on the simplified map, and drawing a line connecting the position of the robot and the destination point.

In various embodiments, the second type of command may include a natural-language expression regarding compliance requirements that the robot is to comply with during the operation of the robot.

In various embodiments, the space may include a first object that does not change position over time, a second object that does not change position during at least a portion of a time period of the operation of the robot, and a third object that continuously changes position over time, and the simplified map may reflect only a portion of the first object.

In various embodiments, the first type of command and the second type of command may be different types of commands. The second interface may include a first command component of a second interface for the user to input a natural-language command, and a second command component of the second interface for inputting predefined compliance requirements of the robot to the second-1 interface according to a selection made by the user. The displaying of the update information may include displaying, on the simplified map of the first interface, a first movement route corresponding to the first type of command and a second movement route along which the robot actually moves according to the first type of command and the second type of command. The screen may further include a third interface for displaying a real-time image acquired by the robot. The displaying of the update information may include displaying a virtual object on the real-time image of the third interface by projecting a size of the robot in the space onto the real-time image.

An embodiment of the present disclosure provides a method of controlling a robot based on a simplified map and a natural-language command. The method may include: acquiring an image of a space; acquiring a simplified map of the space, the simplified map including a current position of a robot and a destination position of the robot and not including at least some elements describing the space; acquiring a natural-language command specifying compliance requirements that the robot is to comply with during an operation of the robot; generating input tokens based on at least one of the image, the simplified map, and the natural-language command; and generating waypoint tokens by processing the input tokens with a trained vision-language-action model.

In various embodiments, the trained vision-language-action model may be a model trained to learn a relationship between the input tokens and the waypoint tokens, the input tokens may include the image of the space, the simplified map of the space including the current position and the destination position of the robot, and the natural-language command specifying the compliance requirements, and the waypoint tokens may include at least one waypoint defining a movement route of the robot at least one future time point.

In various embodiments, the trained vision-language-action model may be a model trained to extract, from the input tokens, current features of the space, geographical features of the space, and features regarding the compliance requirements, and to generate the waypoint tokens based on the extracted features.

In various embodiments, the trained vision-language-action model may be a model trained to output action-type data for controlling the robot in response to receiving vision-type data and language-type data related to control of the robot. The vision-type data may include the image of the space and the simplified map of the space that includes the current position and the destination position of the robot, the language-type data may include the natural-language command specifying the compliance requirements that the robot be to comply with during the operation of the robot, and the action-type data may include a control command for controlling the operation of the robot in the space.

In various embodiments, the space may include a first object that does not change position over time, a second object that does not change position during at least a portion of a time period of the operation of the robot, and a third object that continuously changes position over time, and the simplified map may reflect only a portion of the first object.

In various embodiments, the simplified map may include the destination position of the robot that is defined by a user's input selected from drawing a destination point on the simplified map, drawing a route including the destination point on the simplified map, and drawing a line connecting a position of the robot and the destination point. After the generating of the waypoint tokens, the method further may include controlling the robot based on the waypoint tokens.

In various embodiments, the controlling of the robot may include controlling the robot by inputting the waypoint tokens to a robot controller, wherein the waypoint tokens may include at least one waypoint defining a movement route of the robot at least one future time point, and each of the at least one waypoint may include a direction feature indicating a direction toward a next waypoint and a distance feature reflecting a distance to the next waypoint.

According to the present disclosure, a robot may be controlled based on a simplified map and a natural-language command. In addition, a robot may be controlled by setting compliance requirements in natural-language form, without separate rule-based coding. In addition, a robot is enabled to make autonomous judgements and decisions in unexpected situations. In addition, a robot may be controlled even without precise sensing data regarding an environment in which the robot operates.

### BRIEF DESCRIPTION OF DRAWINGS

FIG. 1 is a view schematically illustrating a configuration of a robot control system according to various embodiments described herein.

FIG. 2 is a view schematically illustrating a configuration of a server 100 according to various embodiments described herein.

FIG. 3 is a view schematically illustrating a configuration of a robot 200 according to various embodiments described herein.

FIG. 4 is a screen 500 showing an example of a user interface provided by the server 100.

FIG. 5 illustrates a first type of command through a first interface.

FIG. 6 illustrates a second type of command through the first interface.

FIG. 7 illustrates a third type of command through the first interface.

FIGS. 8, 9, 10, and 11 are views illustrating various types of user input through a second interface, where FIG. 8 illustrates a first example of user input through a second interface, FIG. 9 illustrates a second example of user input through the second interface, FIG. 10 illustrates a third example of user input through the second interface, and FIG. 11 illustrates a fourth example of user input through the second interface.

FIG. 12 is a view illustrating a first interface in which update information is reflected according to operations of the robot.

FIG. 13 is a flowchart illustrating a method of providing a user interface for robot control performed by a user terminal, according to various embodiments described herein.

FIG. 14 is a view illustrating another method of controlling a robot 200 based on a simplified map and a natural-language command, according to various embodiments described herein.

FIG. 15 is a view illustrating a process of training a vision-language-action model, according to various embodiments described herein.

FIG. 16 is a flowchart illustrating a robot control method used by a robot based on a simplified map and a natural-language command, according to various embodiments described herein.

FIG. 17 is a flowchart illustrating a robot control method used by a server based on a simplified map and a natural-language command, according to various embodiments described herein.

### DETAILED DESCRIPTION

According to various embodiments described herein, a method of providing a user interface for controlling a robot based on a simplified map and a natural-language command may include: displaying a screen including a first interface and a second interface, wherein the first interface may be for displaying a simplified map of a space and a position of a robot and acquiring a first type of command from a user via the simplified map, and the second interface may be for acquiring a second type of command that the robot is to comply with during an operation of the robot; acquiring a user's input via at least one interface displayed on the screen; and displaying, on the screen, update information generated by the user's input and update information generated by the operation of the robot.

The present disclosure may have various different forms and various embodiments, and specific embodiments are illustrated in the accompanying drawings and are described herein in detail. Effects and features of the present disclosure, and methods of achieving the effects and features will become apparent with reference to the accompanying drawings and the embodiments described below in detail. However, the present disclosure is not limited to the embodiments described below and may be implemented in various forms.

Hereinafter, embodiments of the present disclosure will be described with reference to the accompanying drawings. In the drawings, like reference numerals denote like elements, and overlapping descriptions thereof will be omitted.

In the following descriptions of the embodiments, terms such as “first” and “second” are used for distinguishing one element from another element, and are not intended to have any limiting meanings. In the following descriptions of the embodiments, the terms of a singular form may include plural forms unless referred to the contrary. In the following descriptions of the embodiments, terms such as “include,” “comprise,” or “have” specify the presence of stated features or elements, but do not preclude the presence or addition of one or more other features or elements. In the drawings, the sizes of elements may be exaggerated or reduced for ease of illustration. For example, in the drawings, the size or shape of each element may be arbitrarily shown for illustrative purposes, and thus the present disclosure should not be construed as being limited thereto.

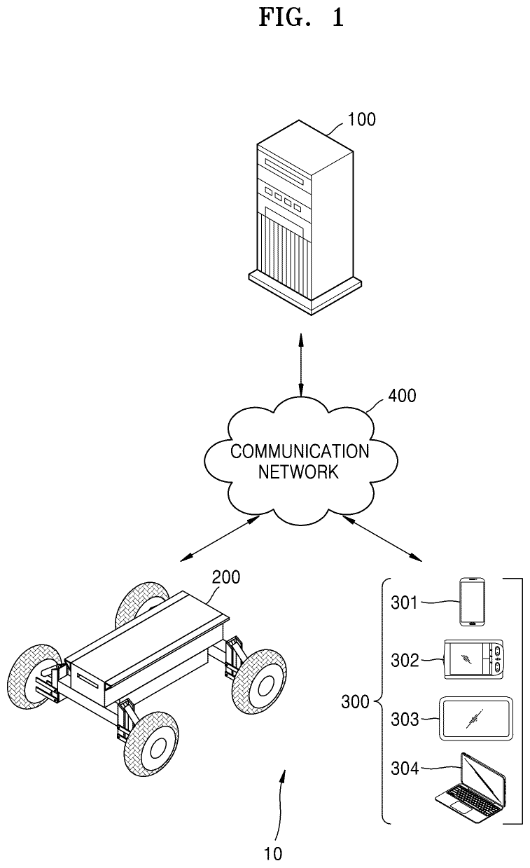

FIG. 1 is a view schematically illustrating a configuration of a robot control system 10 according to various embodiments described herein. The robot control system 10 may control a robot based on a simplified map and a natural-language command. To this end, the robot control system 10 may provide a user interface to receive the simplified map and the natural-language command. As illustrated in FIG. 1, the robot control system 10 may include a server 100, a robot 200, a user terminal 300, and a communication network 400.

In the present disclosure, the term “robot” may refer to a mechanical apparatus that is programmed to perform various tasks at least partially in an automated manner. For example, the robot may be a transport robot for carrying a specific object to a specific location or a security robot for continuously monitoring whether any abnormality occurs within a target space. In addition, the robot may be an agricultural robot for performing specific tasks, such as spraying pesticides in a space where plants or trees are cultivated, such as an orchard. The robot may also be a military robot used for purposes such as land-mine detection or reconnaissance.

However, such usages and/or purposes of the robot are merely illustrative, and the spirit of the present disclosure is not limited thereto.

The server 100 may provide a user with an interface through which the user may input a simplified map and a natural-language command by using the user terminal 300. In addition, the server 100 may generate waypoints (or control signals) for robot movement based on data received from the robot 200 and the user terminal 300. Additionally or alternatively, the server 100 may provide data received from the user terminal 300 to the robot 200, thereby allowing the robot 200 to generate waypoints (or control signals). In this case, the server 100 may provide a trained vision-language-action model to the robot 200. In various embodiments of the present disclosure, the robot 200 may be a mechanical apparatus programmed to perform tasks at least partially in an automated manner according to intended purposes.

In various embodiments according to the present disclosure, the term “simplified map” may refer to a map that reflects only at least some features of a space depicted by the map. For example, when a space includes a first object that does not change position over time, a second object that does not change position during at least a portion of the time period of an operation of the robot, and a third object that continuously changes position over time, the simplified map may reflect only a portion of the first object. For instance, when the space is an indoor environment, elements such as columns or walls may correspond to the first object, furniture that does not change position unless moved by an external force may correspond to the second object, and people in the space may correspond to the third object. Here, the simplified map may be a map reflecting only at least some of the elements of the space such as columns or walls, that is, a map reflecting only a portion of the first object. That is, the simplified map may need to be detailed enough to specify a current position of the robot and the destination position of the robot, and may not need to reflect all objects in the space.

In various embodiments according to the present disclosure, the simplified map may correspond to a sketch map showing only main routes or ways, or may correspond to a map showing only major columns or walls. However, these are merely examples of simplified maps, and the spirit of the present disclosure is not limited thereto.

In various embodiments according to the present disclosure, the term “natural-language command” may refer to a command expressed in natural language, that is, characters understandable by humans, to specify compliance requirements that the robot should comply with during operations of the robot. Such natural-language commands are used for controlling the robot and may serve as guidelines for operations of the robot.

In various embodiments of the present disclosure, the enforcement levels of natural-language commands may be separately set. For example, the natural-language command “do not collide with humans while moving” may be set with a high enforcement level for serving robots. In contrast, the natural-language command “avoid trees while moving” may be set with a relatively low enforcement level for agricultural robots.

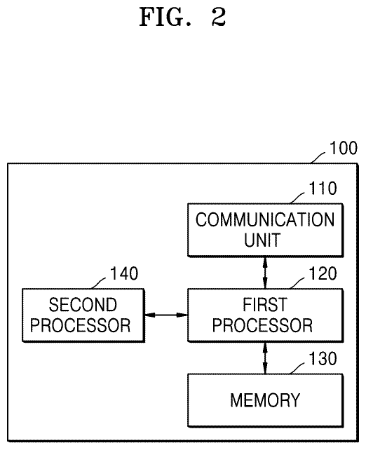

FIG. 2 is a view schematically illustrating a configuration of the server 100 as shown in FIG. 1 according to various embodiments described herein. Referring to FIG. 2, the server 100 may include a communication unit 110, a first processor 120, memory 130, and a second processor 140. Although not shown in FIG. 2, the server 100 may further include an input/output unit, a program storage unit, or the like.

The communication unit 110 may be a device including hardware and software necessary for the server 100 to exchange signals such as control signals or data signals through wired or wireless connections with other devices of the robot control system, such as the robot 200 and/or the user terminal 300.

The first processor 120 may be a device that controls a series of processes for generating input tokens from received data and generating waypoint tokens using the trained vision-language-action model. In other embodiments of the present disclosure, the first processor 120 may be a device that controls a series of processes for providing data necessary for the robot 200 to generate waypoint tokens.

For example, the term “processor” may refer to a data processing device embedded in hardware and having a physically structured circuit for performing functions expressed as code or instructions included in a program. Examples of the data processing device embedded in hardware may include a microprocessor, a central processing unit (CPU), a processor core, a multiprocessor, an application-specific integrated circuit (ASIC), a field programmable gate array (FPGA), and the like. However, the scope of the present disclosure is not limited thereto.

The memory 130 has a function of temporarily or permanently storing data processed by the server 100. The memory 130 may include a magnetic storage medium or a flash storage medium. However, the scope of the present disclosure is not limited thereto. For example, the memory 130 may temporarily and/or permanently store data (e.g., coefficients) that constitute a trained artificial neural network. In addition, the memory 130 may store data such as training data to train an artificial neural network. However, these are only examples, and the spirit of the present disclosure is not limited thereto.

The second processor 140 may be a device that performs computations under control by the first processor 120 described above. In this case, the second processor 140 may have greater computational capability than the first processor 120. For example, the second processor 140 may be configured as a graphics processing unit (GPU) and/or a neural processing unit (NPU). However, these are only examples, and the spirit of the present disclosure is not limited thereto. In an embodiment of the present disclosure, one or more second processors 140 may be provided.

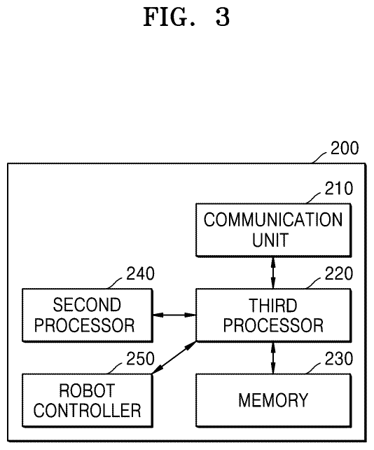

FIG. 3 is a view schematically illustrating a configuration of the robot 200 according to various embodiments described herein. Referring to FIG. 3, the robot 200 may include a communication unit 210, a third processor 220, a memory 230, a fourth processor 240, and a robot controller 250. Although not shown in FIG. 3, the robot 200 may further include a power supply unit (not shown), an actuator (not shown), a controller (not shown), or the like, depending on the purpose and/or type of the robot 200.

The communication unit 210 may be a device including hardware and software necessary for the robot 200 to exchange signals such as control signals or data signals through wired or wireless connections with other network devices of the robot control system, such as the server 100 and/or the user terminal 300.

In an embodiment of the present disclosure, the third processor 220 may acquire an image of a space and transmit the image to the server 100. In another embodiment of the present disclosure, the third processor 220 may be a device that controls a series of processes for generating input tokens from acquired or received data and generating waypoint tokens using the trained vision-language-action model.

For example, the term “processor” may refer to a data processing device embedded in hardware and having a physically structured circuit for performing functions expressed as code or instructions included in a program. Examples of the data processing device embedded in hardware may include a microprocessor, a central processing unit (CPU), a processor core, a multiprocessor, an application-specific integrated circuit (ASIC), a field programmable gate array (FPGA), and the like. However, the scope of the present disclosure is not limited thereto.

The memory 230 has a function of temporarily or permanently storing data processed by the robot 200. The memory 230 may include a magnetic storage medium or a flash storage medium. However, the scope of the present disclosure is not limited thereto. For example, the memory 230 may temporarily and/or permanently store a simplified map and a natural-language command received from the server 100. However, these are only examples, and the spirit of the present disclosure is not limited thereto.

The fourth processor 240 may be a device that performs computations under control by the third processor 220 described above. In this case, the fourth processor 240 may have greater computational capability than the third processor 220. For example, the fourth processor 240 may be configured as a graphics processing unit (GPU) and/or a neural processing unit (NPU). However, these are only examples, and the spirit of the present disclosure is not limited thereto. In an embodiment of the present disclosure, one or more fourth processors 240 may be provided.

According to various embodiments described herein, the user terminal 300 may provide a user with a user interface received from the server 100, obtain user input through the user interface, and transmit the user input to the server 100.

Referring back to FIG. 1, the user terminal 300 may be a portable terminal such as portable terminals 301, 302, and 303, or may be a computer 304. Although not shown in FIG. 1, the user terminal 300 may include a communication unit (not shown), a fifth processor (not shown), a memory (not shown), a display (not shown), and a user interface unit (not shown). However, the configuration described above is only an example, and the spirit of the present disclosure is not limited thereto.

Hereinafter, a process in which the server 100 obtains a simplified map and a natural-language command through the user terminal 300 will be described and then, a process of controlling the robot 200 based on the simplified map and the natural-language command will be described.

### Process of Acquiring Simplified Map and Natural-Language Command

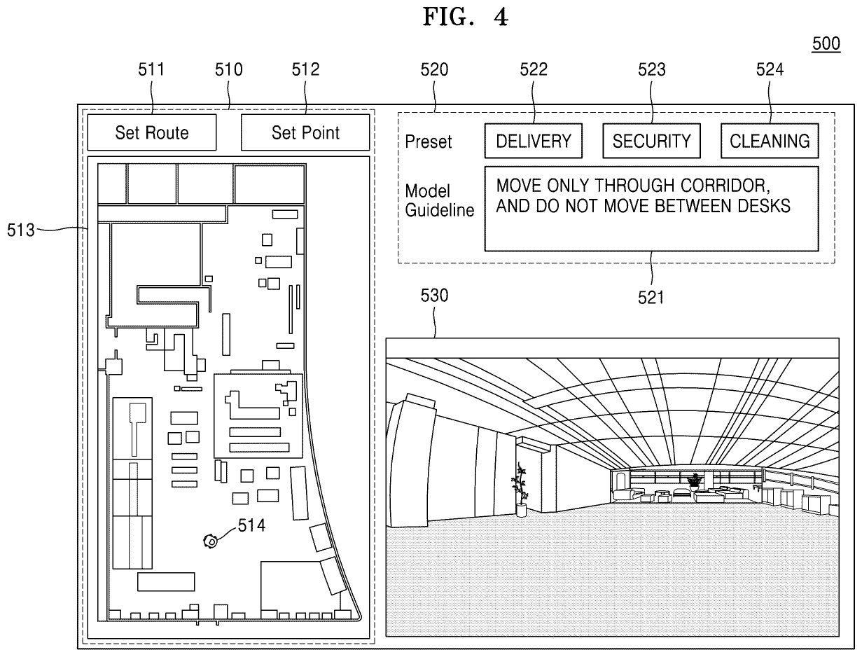

FIG. 4 is a screen 500 showing an example of a user interface provided by the server 100.

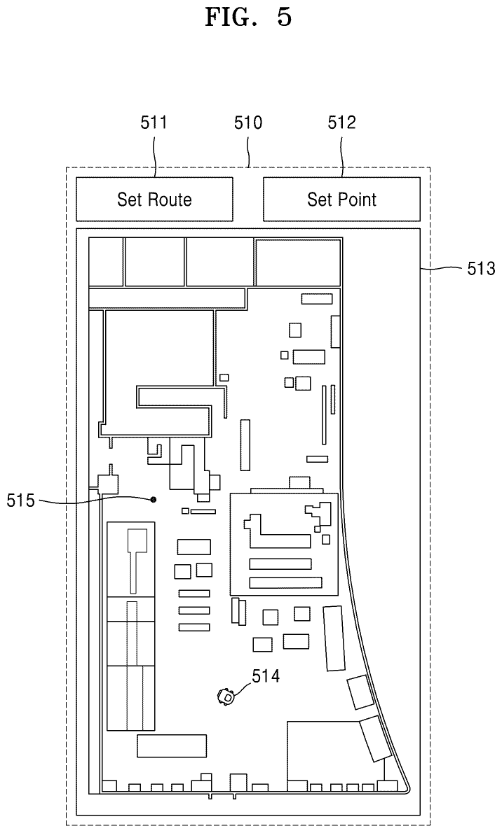

According to various embodiments described herein, the server 100 may provide the user terminal 300 with a user interface such as the screen 500 shown in FIG. 5, thereby acquiring user input. The following description will focus on processes performed by the user terminal 300.

As illustrated in FIG. 5, the user terminal 300 may display the screen 500 that includes a first interface 510 for displaying a simplified map of a space and a position 514 of the robot 200 and acquiring a user's first type of command on the simplified map, a second interface 520 for acquiring a user's second type of command that the robot 200 should comply with during operations, and a third interface 530 for displaying real-time images acquired by the robot 200. Here, the second type of command may be a natural-language command regarding compliance requirements that the robot 200 should comply with during operations.

In various embodiments, the first interface 510 may include, in addition to an interface 513 for displaying the simplified map, interfaces 511 and 512 for selecting a method of inputting the user's first type of command. For example, when a user performs an input through the interface 511, the user may input a first type of command by drawing a route on the interface 513. In addition, when a user performs an input through the interface 512, the user may input the first type of command by drawing a destination point on the interface 513. However, these methods are only examples, and the spirit of the present disclosure is not limited thereto.

In an embodiment of the present disclosure, the second interface 520 may include a first command component 521 for a user to input a natural-language command, and a plurality of second command components 522, 523, and 524 for inputting predefined compliance requirements for the robot 200 into the first command component 521 according to a user's selection.

According to various embodiments described herein, the user terminal 300 as shown in FIG. 1 may acquire a user's input through the at least one interface displayed on the screen 500.

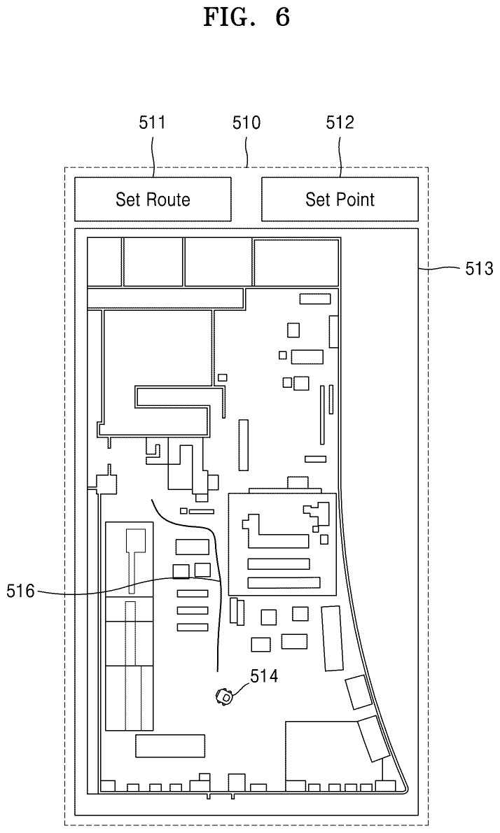

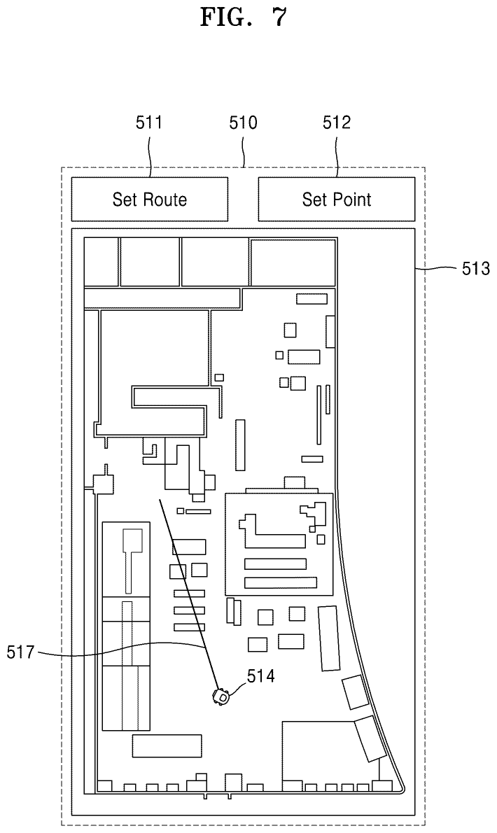

FIGS. 5 to 7 are views illustrating various types of user input through the first interface 510 as shown in FIG. 4. FIG. 5 illustrates a first type of command 515 on the first interface 510, FIG. 6 illustrates a second type of command 516 on the first interface 510, and FIG. 7 illustrates a third type of command 517 on the first interface 510.

As described above in connection with FIG. 4, the first interface 510 may be an interface for acquiring the first type of command. Here, the first type of command implements various types of commands that input a destination point by drawing on a simplified map. For example, as illustrated in FIG. 5, the first type of command may take the form of drawing a destination point 515 on a simplified map of the interface 513. Additionally or alternatively, as illustrated in FIG. 6, the second type of command 516 may take the form of drawing a route 516 including a destination point on a simplified map of the interface 513. Additionally or alternatively, as illustrated in FIG. 7, the third type of command 517 may take the form of drawing a line connecting a robot's position 514 and a destination point on a simplified map of the interface 513. However, the first, the second and the third types of commands 515, 516,and 517 illustrated in FIGS. 5 to 7 are non-limiting examples, and the spirit of the present disclosure is not limited thereto.

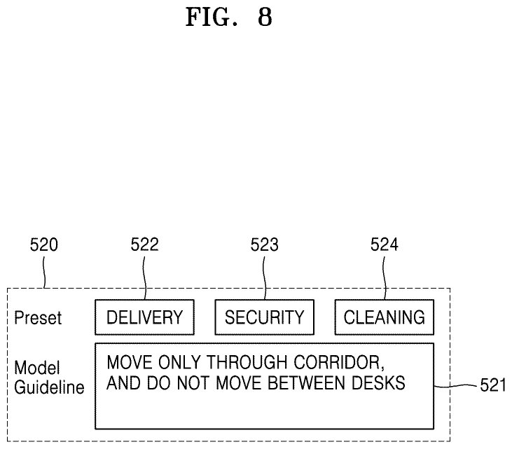

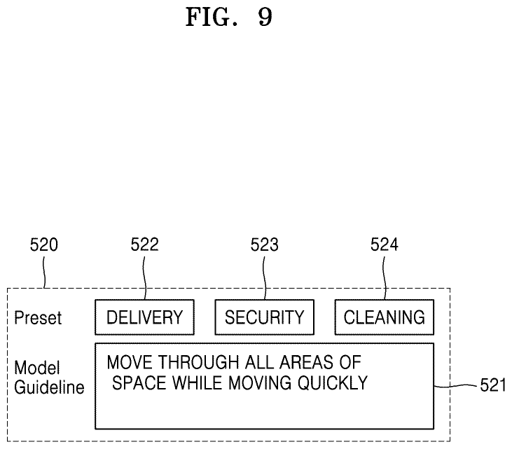

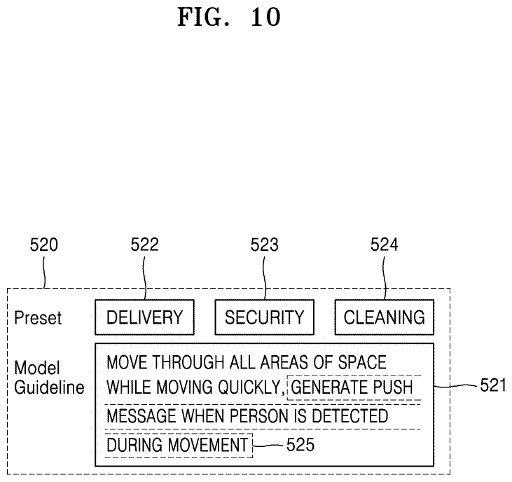

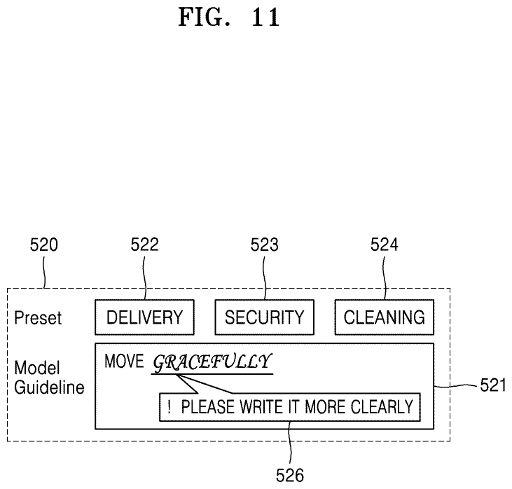

FIGS. 8 to 11 are views illustrating various examples of user input through the second interface 520 as shown in FIG. 4. More specifically, FIG. 8 illustrates a first example of user inputs through the second interface, FIG. 9 illustrates a second example of user inputs through the second interface, FIG. 10 illustrates a third example of user inputs through the second interface, and FIG. 11 illustrates a fourth example of user inputs through the second interface.

According to various embodiments described herein, the second interface 520 may be an interface for acquiring the second type of command. Here, the second type of command may be a natural-language command regarding compliance requirements that the robot 200 should comply with during operations. For example, as illustrated in FIG. 8, the second type of command may be a textual description of compliance requirements that the robot 200 should comply with during operations, such as “Move only through the corridor and do not move between the desks.” As described above, in the present disclosure, the first type of command and the second type of command may differ from each other.

In an embodiment of the present disclosure, the second command may be acquired in the form of a user's selection of the plurality of second command components 522, 523, and 524 522, 523, and 524.

For example, as illustrated in FIG. 9, a second command may be acquired by a user's input through the second command component indicating “security” 523. In this case, a natural-language command corresponding to “security” may be automatically entered into the first command component 521.

The second command may be acquired by a user's input through the plurality of second command components 522, 523, and 524 and a user's modifying input into the first command component 521. For instance, as illustrated in FIG. 10, the second command may be acquired by a user's input through the second command component 523 indicating “security” and an additional input 525. In this case, a natural-language command corresponding to “security” may also be automatically entered into the second-1 interface 521.

Alternatively or additionally, the second interface 520 may provide a validity check result for the second command. For example, as illustrated in FIG. 11, the second interface 520 may distinguishably display a portion (i.e., “GRACEFULLY”) that is determined to be invalid in the input entered into the first command component 521, and may provide a review result 526 regarding the invalid portion.

Alternatively or additionally, the second interface 520 may further include an interface for setting the enforcement levels of second commands. For example, the second interface 520 may include an interface for setting the enforcement levels of second commands in the form of a slider bar. Here, the “enforcement levels” may refer to degrees to which the robot 200 should comply with second commands during operations, or degrees of freedom permitted for violating second commands.

According to various embodiments described herein, the user terminal 300 may display, on the screen 500, update information generated by a user's input through the interfaces 510 and 520, and update information generated by the robot 200 operating according to commands.

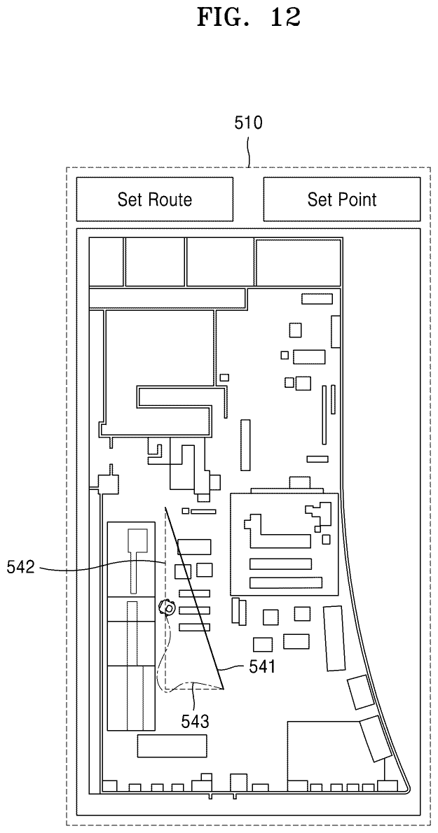

FIG. 12 is a view illustrating another embodiment of the first interface 510 in which update information is reflected according to operations of the robot 200. The user terminal 300 may display, on a simplified map of the first interface 510, a first movement route 542 by the first type of command and a second movement route 543 along which the robot 200 actually moves according to the first type of command and the second type of command. Here, the first movement route 542 may be a movement plan according to the first type of command.

In an optional embodiment of the present disclosure, the user terminal 300 may also display, on the simplified map, an object 541 following the first type of command together with the other routes, that is, the first and second movement routes 542 and 543.

Referring back to FIG. 4, according to various embodiments described herein, the user terminal 300 may display a virtual object on the third interface 530 by projecting the size of the robot 200 in the space onto a real-time image. A user may use the virtual object projected onto the space through which the robot 200 is to travel, to determine whether the robot 200 can pass through the space.

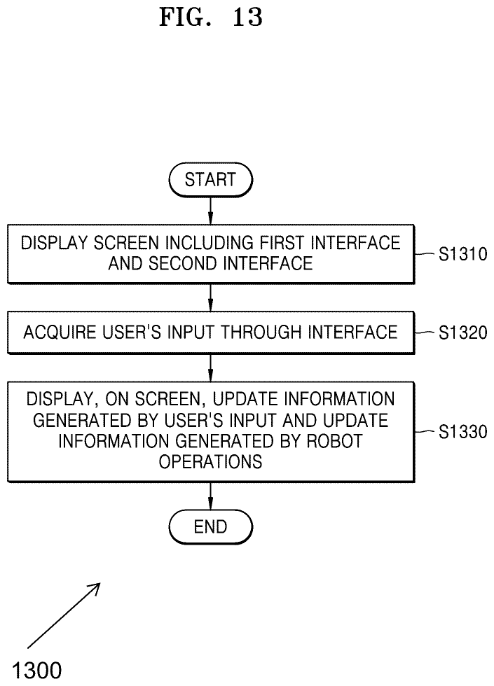

FIG. 13 is a flowchart illustrating a method 1300 of providing a user interface for robot control performed by the user terminal 300, according to various embodiments described herein. Hereinafter, the method will be described by referring to FIGS. 4 to 12 again. The method 1300 includes displaying a screen including a first interface and a second interface (S1310). For instance, as depicted in FIG. 4, the screen 500 is displayed as an example of a user interface provided by the server 100. As illustrated in FIG. 5,, the user terminal 300 may display a screen 500 that includes the first interface 510 for displaying a simplified map of a space and the position 514 of the robot 200 and acquiring a user's first type of command on the simplified map, the second interface 520 for acquiring a user's second type of command that the robot 200 should comply with during operations, and the third interface 530 for displaying real-time images acquired by the robot 200 (S1310).

The first interface 510 may include, in addition to the interface 513 for displaying the simplified map, interfaces 511 and 512 for selecting a method of inputting the user's first type of command. For example, when a user performs an input through the interface 511, the user may input the first type of command by drawing a route on the interface 513. In addition, when a user performs an input through the interface 512, the user may input the first type of command by drawing a destination point on the interface 513. However, these methods are only examples, and the spirit of the present disclosure is not limited thereto.

The second interface 520 may include a second-1 interface 521 for a user to input a natural-language command, and second-2 interfaces 522, 523, and 524 for inputting predefined compliance requirements for the robot 200 into the second-1 interface 521 according to a user's selection.

The method 1300 further includes acquiring, via the user terminal 300, a user's input through at least one interface displayed on the screen 500 (S1320).

As shown in FIGS. 5 through 7, the first interface 510 may be an interface for acquiring the first type of command. Here, the first type of command may be a concept encompassing various types of commands that input a destination point by drawing on a simplified map. For example, as illustrated in FIG. 5, the first type of command may take the form of drawing a destination point 515 on a simplified map of the interface 513. In addition, as illustrated in FIG. 6, the first type of command may take the form of drawing a route 516 including a destination point on a simplified map of the interface 513. In addition, as illustrated in FIG. 7, the first type of command may take the form of drawing a line 517 connecting a robot's position 514 and a destination point on a simplified map of the interface 513. However, the types illustrated in FIGS. 5 to 7 are only examples, and the spirit of the present disclosure is not limited thereto.

As shown in FIGS. 8 through 11, the second interface 520 may be an interface for acquiring the second type of command. Here, the second type of command may be a natural-language command regarding compliance requirements that the robot 200 should comply with during operations. For example, as illustrated in FIG. 8, the second type of command may be a textual description of compliance requirements that the robot 200 should comply with during operations, such as “Move only through the corridor and do not move between the desks.” As described above, in the present disclosure, the first type of command and the second type of command may differ from each other. The second command may be acquired in the form of a user's selection of the second command components 522, 523, and 524.

For example, as illustrated in FIG. 9, a second command may be acquired by a user's input through one of the second command components indicating “security” 523. In this case, a natural-language command corresponding to “security” may be automatically entered into the first command component 521.

The second command may be acquired by a user's input through the second command components 522, 523, and 524 and a user's modifying input into the first command component 521. For instance, as illustrated in FIG. 10, the second command may be acquired by a user's input through the second command component indicating “security” 523 and an additional input 525. In this case, a natural-language command corresponding to “security” may also be automatically entered into the first command component 521.

Alternatively, the second interface 520 may provide a validity check result for the second command. For example, as illustrated in FIG. 11, the second interface 520 may distinguishably display a portion (“GRACEFULLY”) that is determined to be invalid in the input entered into the second-1 interface 521, and may provide a review result 526 regarding the invalid portion.

In another optional embodiment of the present disclosure, the second interface 520 may further include an interface for setting the enforcement levels of second commands. For example, the second interface 520 may include an interface for setting the enforcement levels of second commands in the form of a slider bar. Here, the “enforcement levels” may refer to degrees to which the robot 200 should comply with second commands during operations, or degrees of freedom permitted for violating second commands.

The method 1300 further includes displaying, on a screen, update information generated by a user's input through the interfaces 510 and 520, and update information generated by robot operations according to commands (S1330).

As shown in FIG. 12, the user terminal 300 may display, on a simplified map of the first interface 510, the first movement route 542 by the first type of command and a second movement route 543 along which the robot 200 actually moves according to the first type of command and the second type of command. Here, the first movement route 542 may be a movement plan according to the first type of command.

Alternatively, the user terminal 300 may also display, on the simplified map, an object 541 following the first type of command together with the other routes, that is, the first and second movement routes 542 and 543.

Referring back to FIG. 4, the user terminal 300 may display a virtual object on the third interface 530 by projecting the size of the robot 200 in the space onto a real-time image. A user may use the virtual object projected onto the space through which the robot 200 is to travel, to determine whether the robot 200 can pass through the space.

### Process of Controlling Robot Based on A Simplified Map and Natural-Language Command

The following description will be presented on the premise that a simplified map and a natural-language command have been acquired through a user interface according to the processes described above.

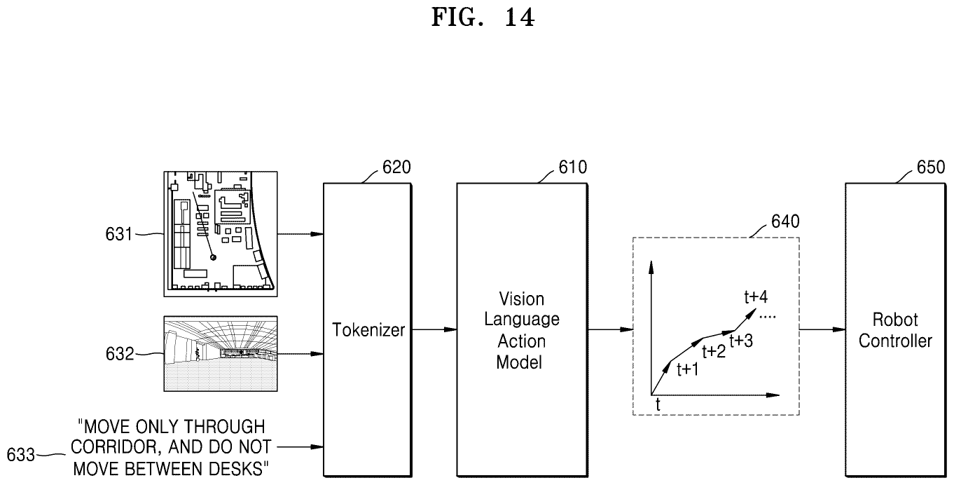

FIG. 14 is a view illustrating a method 1400 of controlling a robot based on a simplified map and a natural-language command, according to various embodiments described herein. For instance, the robot 200 may acquire an image 632 of a space. For example, the robot 200 may acquire the image 632 of the space during operations by using an image acquisition unit (not shown). The acquired image 632 may be used for controlling the robot 200, and may also be transmitted to the server 100 to allow a user to check the situation of the robot 200, as shown in FIG. 1.

The robot 200 may acquire a simplified map 631 of the space that includes the current position and the destination position of the robot 200. In addition, according to the embodiment of the present disclosure, the robot 200 may acquire a natural-language command 633 specifying compliance requirements that the robot 200 should comply with during operations.

In the embodiment of the present disclosure, the robot 200 may receive the simplified map 631 and the natural-language command 633 from the server 100. In this case, the server 100 may provide the user terminal 300 with an interface for acquiring the simplified map 631 and the natural-language command 633, receive a user's input through the interface, and provide the user's input to the robot 200. As described above, in the present disclosure, the term “simplified map” may refer to a map in which at least some elements describing a space are omitted, and a detailed explanation thereof is omitted here.

In various embodiments, the robot 200 may generate input tokens based on at least one of the acquired image 632, the received simplified map 631, and the received command 633. For example, the robot 200 may input the acquired image 632, the received simplified map 631, and the received command 633 into a tokenizer 620 to generate input tokens. The robot 200 may process the input tokens generated according to the process described above by using a trained vision-language-action model 610 to generate waypoint tokens 640. A robot controller 650 may convert the generated waypoints into specific robot control signals.

In another embodiment of the present disclosure, the trained vision-language-action model 610 may generate robot control signals by processing the input tokens. In this case, the robot controller 650 may be omitted.

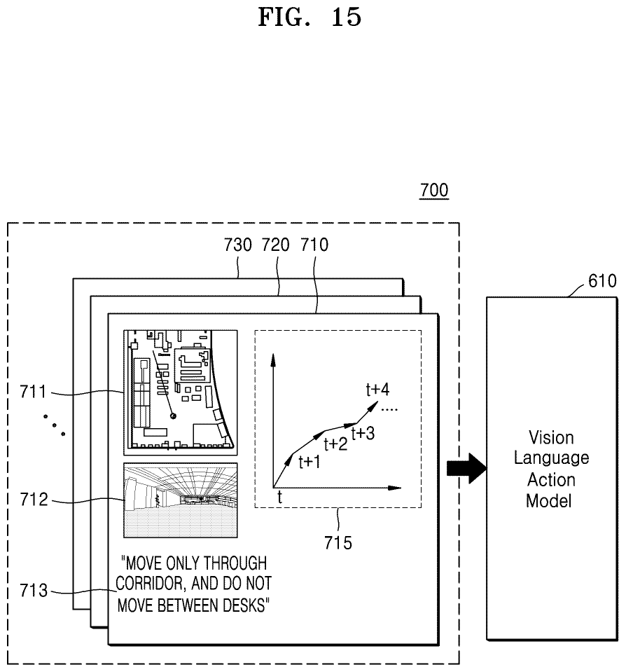

FIG. 15 is a view illustrating a process of training the vision-language-action model 610 according to various embodiments described herein. The vision-language-action model 610 may be a model trained to learn a relationship between input tokens and waypoint tokens, wherein the input tokens include an image of a space, a simplified map of the space including the current position and the destination position of a robot, and a natural-language command regarding compliance requirements, and the waypoint tokens include at least one waypoint defining a movement route of the robot at least one future time point. In other words, the vision-language-action model 610 may be a model trained to output waypoint tokens including at least one waypoint defining a movement route of a robot at least one future time point when input tokens including an image of a space, a simplified map of the space including the current position and the destination position of the robot, and a natural-language command regarding compliance requirements are input.

Additionally or alternatively, the vision-language-action model 610 may be a model trained to output a robot control signal (or tokens including a robot control signal) at least one future time point when input tokens including an image of a space, a simplified map of the space including the current position and the destination position of the robot, and a natural-language command regarding compliance requirements are input.

In other embodiments, the vision-language-action model 610 may be a model trained to output waypoint tokens including at least one waypoint defining a movement route of a robot at least one future time point, a text describing an operating situation (or driving situation) of the robot, and a text describing a decision made by the robot in the situation, when input tokens including an image of a space, a simplified map of the space including the current position and the destination position of the robot, and a natural-language command regarding compliance requirements are input.

The vision-language-action model 610 may be trained based on training data 700. Here, each piece of the training data 700 may include an image of a space, a simplified map of the space including the current position and the destination position of a robot, a natural-language command regarding compliance requirements, and at least one waypoint defining a movement route of the robot at least one future time point. For example, a first training data piece 710 may include an image 712 of a space, a simplified map 711 of the space including the current and destination positions of a robot, a natural-language command 713 regarding compliance requirements, and at least one waypoint 715 defining a movement route of the robot at least one future time point. Similarly, a second training data piece 720 and a third training data piece 730 may also include such items.

In other embodiments, the first training data piece 710 may include a specific robot control signal (not shown) in place of the at least one waypoint 715. The first training data piece 710 may further include a natural-language text (not shown) describing an operating situation (or driving situation) of a robot and a natural-language text (not shown) describing a decision made by the robot in the situation.

In the process of training the vision-language-action model 610, individual items included in the training data 700 may be tokenized for use. For example, an input token may be generated from input data items 711, 712, and 713 of the first training data piece 710, and an output token may be generated from an output data item 715 of the first training data piece 710. Then, the tokens may be respectively used as input data and output data of the vision-language-action model 610.

In the training process, the vision-language-action model 610 of the embodiment of the present disclosure may extract current features of the space, geographical features of the space, and features of compliance requirements from input tokens during the training process. The vision-language-action model 610 may also be trained to generate waypoint tokens based on the extracted features.

The vision-language-action model 610 of the embodiment of the present disclosure may be a model trained to output action-type data for controlling the robot 200 when vision-type data and language-type data related to the control of the robot 200 are input.

Here, the vision-type data may include an image of the space and a simplified map of the space including the current position and the destination position of the robot 200. The language-type data may include a natural-language command specifying compliance requirements that the robot 200 should comply with during operations. The action-type data may include a control command for controlling the operation of the robot 200 in the space. The robot 200 may be controlled based on waypoint tokens generated through the process described above.

More specifically, the robot 200 may be controlled by inputting waypoint tokens into the robot controller 650. Here, the waypoint tokens may include at least one waypoint defining a movement route of the robot 200 at least one future time point with reference to the current time point, and each of the at least one waypoint may include a direction feature indicating a direction toward the next waypoint and a distance feature reflecting the distance to the next waypoint.

Alternatively or additionally, the trained vision-language-action model 610 may directly generate robot control signals by processing input tokens. In this case, the robot controller 650 may be omitted.

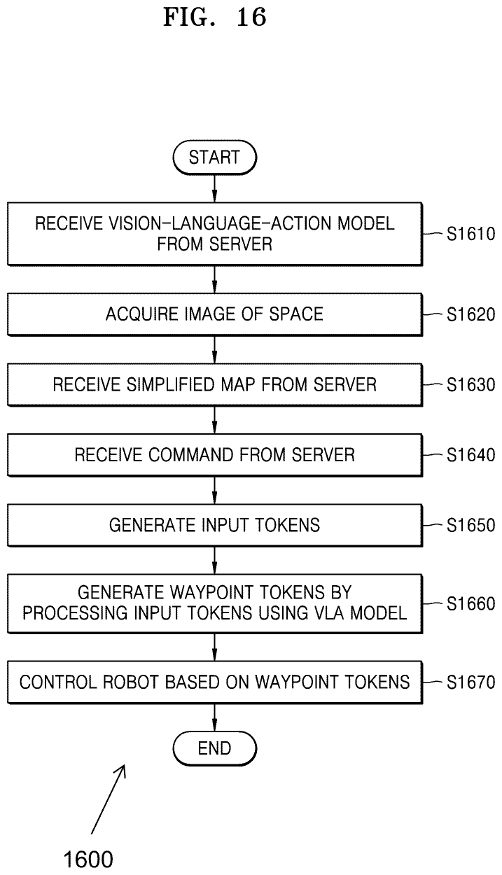

FIG. 16 is a flowchart illustrating a robot control method 1600 used by the robot 200 based on a simplified map and a natural-language command, according to various embodiments described herein. The following description of the robot control method 1600 is presented with reference to FIGS. 1, 14 and 15 as well.

According to the embodiment of the present disclosure, the method 1600 includes receiving a vision-language-action model from a server (S1610). For instance, as shown in FIGS. 1 and 14-15, the robot 200 receives the vision-language-action model from the server 100. As shown in FIG. 15 and described above, the vision-language-action model 610 may be a model trained to learn a relationship between input tokens and waypoint tokens, wherein the input tokens include an image of a space, a simplified map of the space including the current position and the destination position of a robot, and a natural-language command regarding compliance requirements, and the waypoint tokens include at least one waypoint defining a movement route of the robot at least one future time point.

In other words, the vision-language-action model 610 may be a model trained to output waypoint tokens including at least one waypoint defining a movement route of a robot at least one future time point when input tokens including an image of a space, a simplified map of the space including the current position and the destination position of the robot, and a natural-language command regarding compliance requirements are input.

Alternatively, the vision-language-action model 610 may be a model trained to output a robot control signal (or tokens including a robot control signal) at least one future time point when input tokens including an image of a space, a simplified map of the space including the current position and the destination position of the robot, and a natural-language command regarding compliance requirements are input. Further alternatively, the vision-language-action model 610 may be a model trained to output waypoint tokens including at least one waypoint defining a movement route of a robot at least one future time point, a text describing an operating situation (or driving situation) of the robot, and a text describing a decision made by the robot in the situation, when input tokens including an image of a space, a simplified map of the space including the current position and the destination position of the robot, and a natural-language command regarding compliance requirements are input.

As shown in FIG. 15 and described above, the vision-language-action model 610 may be trained based on training data 700. Here, each piece of the training data 700 may include an image of a space, a simplified map of the space including the current position and the destination position of a robot, a natural-language command regarding compliance requirements, and at least one waypoint defining a movement route of the robot at least one future time point.

For example, a first training data piece 710 may include an image 712 of a space, a simplified map 711 of the space including the current and destination positions of a robot, a natural-language command 713 regarding compliance requirements, and at least one waypoint 715 defining a movement route of the robot at least one future time point. Similarly, a second training data piece 720 and a third training data piece 730 may also include such items.

Alternatively, the first training data piece 710 may include a specific robot control signal (not shown) in place of the at least one waypoint 715. Further alternatively, the first training data piece 710 may further include a natural-language text (not shown) describing an operating situation (or driving situation) of a robot and a natural-language text (not shown) describing a decision made by the robot in the situation. In the process of training the vision-language-action model 610, individual items included in the training data 700 may be tokenized for use. For example, an input token may be generated from input data items 711, 712, and 713 of the first training data piece 710, and an output token may be generated from an output data item 715 of the first training data piece 710. Then, the tokens may be respectively used as input data and output data of the vision-language-action model 610.

In the training process, the vision-language-action model 610 of the embodiment of the present disclosure may extract current features of the space, geographical features of the space, and features of compliance requirements from input tokens during the training process. The vision-language-action model 610 may also be trained to generate waypoint tokens based on the extracted features. The vision-language-action model 610 of the embodiment of the present disclosure may be a model trained to output action-type data for controlling the robot 200 when vision-type data and language-type data related to the control of the robot 200 are input.

Here, the vision-type data may include an image of the space and a simplified map of the space including the current position and the destination position of the robot 200. The language-type data may include a natural-language command specifying compliance requirements that the robot 200 should comply with during operations. The action-type data may include a control command for controlling the operation of the robot 200 in the space.

The method 1600 further includes acquiring an image of space, for example, by the robot 200 acquiring the image 632 of a space (S1620). As described above in connection with FIG. 4, for example, the robot 200 may acquire the image 632 of the space during operations by using an image acquisition unit (not shown). The acquired image 632 may be used for controlling the robot 200, and may also be transmitted to the server 100 to allow a user to check the situation of the robot 200.

The method 1600 includes receiving a simplified map from the server (S1630). For instance, the robot 200 may acquire the simplified map 631 of the space that includes the current position and the destination position of the robot 200 (S1630). The method 1600 includes acquiring a command from the server (S1640). For instance, the robot 200 may acquire a natural-language command 633 specifying compliance requirements that the robot 200 should comply with during operations (S1640).

The method 1600 further includes generating input tokens (S1650). For instance, the robot 200 may generate input tokens based on at least one of the acquired image 632, the received simplified map 631, and the received command 633 (S1650). For example, the robot 200 may input the acquired image 632, the received simplified map 631, and the received command 633 into the tokenizer 620 to generate input tokens.

The method 1600 includes generating waypoint tokens by processing input tokens using the VLA model (S1660). For instance, the robot 200 may process the input tokens generated according to the process described above by using the trained vision-language-action model 610 to generate waypoint tokens 640 (S1660). The robot controller 650 may convert generated waypoints into specific robot control signals.

Alternatively, the trained vision-language-action model 610 may generate robot control signals by processing the input tokens. In this case, the robot controller 650 may be omitted. The robot 200 may be controlled based on the waypoint tokens generated through the process described above (S1670). More specifically, the robot 200 may be controlled by inputting the waypoint tokens into the robot controller 650. Here, the waypoint tokens may include at least one waypoint defining a movement route of the robot 200 at least one future time point with reference to the current time point, and each of the at least one waypoint may include a direction feature indicating a direction toward the next waypoint and a distance feature reflecting the distance to the next waypoint.

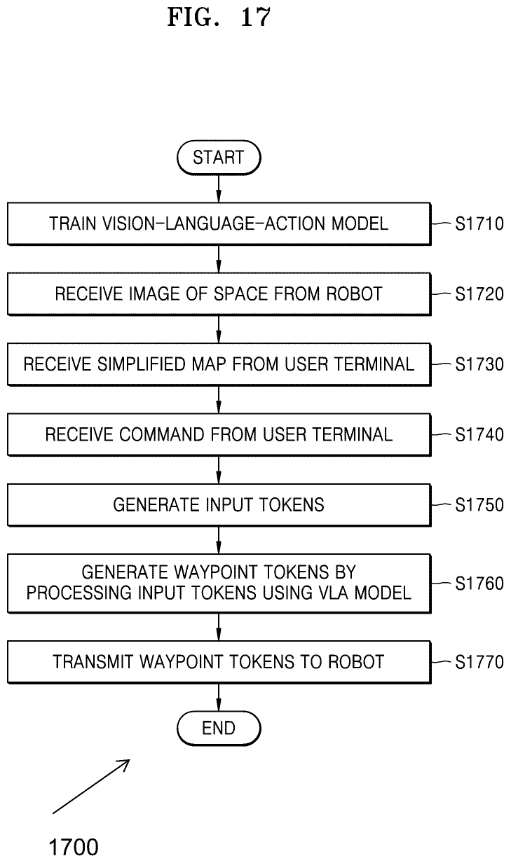

FIG. 17 is a flowchart illustrating a robot control method 1700 used by a server based on a simplified map and a natural-language command, according to various embodiments described herein. The following description of the robot control method 1700 is presented with reference to FIGS. 14 and 15 as well. The robot control method 1700 includes training a vision-language-action model (S1710). For instance, the server 100 may train the vision-language-action model 610 (S1710).

According to various embodiments described herein, the vision-language-action model 610 may be a model trained to learn a relationship between input tokens and waypoint tokens, wherein the input tokens include an image of a space, a simplified map of the space including the current position and the destination position of a robot, and a natural-language command regarding compliance requirements, and the waypoint tokens include at least one waypoint defining a movement route of the robot at least one future time point.

In other words, the vision-language-action model 610 may be a model trained to output waypoint tokens including at least one waypoint defining a movement route of a robot at least one future time point when input tokens including an image of a space, a simplified map of the space including the current position and the destination position of the robot, and a natural-language command regarding compliance requirements are input.

In an optional embodiment of the present disclosure, the vision-language-action model 610 may be a model trained to output a robot control signal (or tokens including a robot control signal) at least one future time point when input tokens including an image of a space, a simplified map of the space including the current position and the destination position of the robot, and a natural-language command regarding compliance requirements are input.

In another optional embodiment of the present disclosure, the vision-language-action model 610 may be a model trained to output waypoint tokens including at least one waypoint defining a movement route of a robot at least one future time point, a text describing an operating situation (or driving situation) of the robot, and a text describing a decision made by the robot in the situation, when input tokens including an image of a space, a simplified map of the space including the current position and the destination position of the robot, and a natural-language command regarding compliance requirements are input.

The vision-language-action model 610 may be trained based on training data 700.

Here, each piece of the training data 700 may include an image of a space, a simplified map of the space including the current position and the destination position of a robot, a natural-language command regarding compliance requirements, and at least one waypoint defining a movement route of the robot at least one future time point.

For example, a first training data piece 710 may include an image 712 of a space, a simplified map 711 of the space including the current and destination positions of a robot, a natural-language command 713 regarding compliance requirements, and at least one waypoint 715 defining a movement route of the robot at least one future time point. Similarly, a second training data piece 720 and a third training data piece 730 may also include such items.

In an optional embodiment of the present disclosure, the first training data piece 710 may include a specific robot control signal (not shown) in place of the at least one waypoint 715.

In another optional embodiment of the present disclosure, the first training data piece 710 may further include a natural-language text (not shown) describing an operating situation (or driving situation) of a robot and a natural-language text (not shown) describing a decision made by the robot in the situation.

In the process of training the vision-language-action model 610, individual items included in the training data 700 may be tokenized for use. For example, an input token may be generated from input data items 711, 712, and 713 of the first training data piece 710, and an output token may be generated from an output data item 715 of the first training data piece 710. Then, the tokens may be respectively used as input data and output data of the vision-language-action model 610.

In the training process, the vision-language-action model 610 of the embodiment of the present disclosure may extract current features of the space, geographical features of the space, and features of compliance requirements from input tokens during the training process. The vision-language-action model 610 may also be trained to generate waypoint tokens based on the extracted features.

The vision-language-action model 610 of the embodiment of the present disclosure may be a model trained to output action-type data for controlling the robot 200 when vision-type data and language-type data related to the control of the robot 200 are input.

Here, the vision-type data may include an image of the space and a simplified map of the space including the current position and the destination position of the robot 200. The language-type data may include a natural-language command specifying compliance requirements that the robot 200 should comply with during operations. The action-type data may include a control command for controlling the operation of the robot 200 in the space.

The robot control method 1700 includes receiving an image of space from a robot (S1720). For instance, as shown in FIG. 1, the server 100 may acquire the image 632 of the space from the robot 200 (S1720).

The robot 200 may acquire an image 632 of a space. For example, the robot 200 may acquire the image 632 of the space during operations by using an image acquisition unit (not shown). The acquired image 632 may be used for controlling the robot 200, and may also be transmitted to the server 100 to allow a user to check the situation of the robot 200. The robot control method 1700 further includes receiving a simplified map from a user terminal (S1730) and receiving a command from the user terminal (S1740). For instance, The server 100 may provide the user terminal 300 with an interface for acquiring the simplified map 631 and the natural-language command 633, and may receive a user's input through the interface (S1730 and S1740). The robot 200 may receive the simplified map 631 and the natural-language command 633 from the server 100.

The robot control method 1700 includes generating input tokens (S1750). For instance, the server 100 may generate input tokens based on at least one of the acquired image 632, the received simplified map 631, and the received command 633 (S1750). For example, the server 100 may input the acquired image 632, the received simplified map 631, and the received command 633 into the tokenizer 620 to generate input tokens.

The robot control method 1700 includes generating waypoint tokens by processing input tokens using the vision-language-action (VLA) model (S1760)For instance, the server 100 may process the input tokens generated according to the process described above by using a trained vision-language-action model 610 to generate waypoint tokens 640 (S1760). The robot controller 650 of the robot 200 may convert generated waypoints into specific robot control signals. Alternatively, the trained vision-language-action model 610 may generate robot control signals by processing the input tokens. In this case, the robot controller 650 of the robot 200 may be omitted.

The robot control method 1700 includes transmitting the waypoint tokens to the robot (S1770). For instance, the server 100 may transmit the waypoint tokens generated through process described above to the robot 200 (S1770). Then, the robot 200 may input the received waypoint tokens into the robot controller 650 to control the robot 200. Here, the waypoint tokens may include at least one waypoint defining a movement route of the robot 200 at least one future time point with reference to the current time point, and each of the at least one waypoint may include a direction feature indicating a direction toward the next waypoint and a distance feature reflecting the distance to the next waypoint. Alternatively, the server 100 may transmit the robot control signals generated through the process described above to the robot 200.

The above-described embodiments of the present disclosure may be implemented in the form of computer programs executable on a computer using various components, and such computer programs may be stored in computer-readable media. In this case, the computer-readable media may be for storing programs executable by a computer. Examples of the computer-readable media may include: magnetic media such as hard disks, floppy disks, and magnetic tapes; optical recording media such as CD-ROMs and DVDs; magneto-optical media such as floptical disks; ROMs; RAMs; and flash memories, which are configured to store program instructions.

In addition, the computer programs may be those designed and configured for the present disclosure or well known in the computer software industry. Examples of the computer programs may include machine codes made by compilers and high-level language codes executable on computers using interpreters.

Specific executions described in the present disclosure are merely examples and do not limit the scope of the present disclosure in any way. For simplicity of the specification, descriptions of known electric components, control systems, software, and other functional aspects thereof may not be given. Furthermore, line connections or connection members between elements depicted in the drawings represent functional connections and/or physical or circuit connections by way of example, and in actual applications, they may be replaced or embodied as various additional functional connections, physical connections, or circuit connections. Elements described without using terms such as “essential” and “important” may not be necessary for constituting the present disclosure.

Therefore, the spirit of the present disclosure is not limited to the embodiments described above, and the appended claims and all ranges equivalent to or equivalently modified from the appended claims should be regarded as falling within the scope of the present disclosure.

1. A method of controlling a robot based on a simplified map and a natural-language command, the method comprising:
acquiring an image of a space;
acquiring a simplified map of the space, the simplified map comprising a current position of a robot in the space and a destination position of the robot and not comprising at least some elements describing the space;
acquiring a natural-language command specifying compliance requirements that the robot is to comply with during an operation of the robot;
generating input tokens based on at least one of the image of the space, the simplified map, and the natural-language command; and
generating waypoint tokens by processing the input tokens with a trained vision-language-action model.

2. The method of claim 1, wherein the trained vision-language-action model is a model trained to learn a relationship between the input tokens and the waypoint tokens, the input tokens comprise the image of the space, the simplified map of the space comprising the current position and the destination position of the robot, and the natural-language command specifying the compliance requirements, and the waypoint tokens comprise at least one waypoint defining a movement route of the robot with respect to at least one future time point.

3. The method of claim 1, wherein the trained vision-language-action model is a model trained to extract, from the input tokens, current features of the space, geographical features of the space, and features regarding the compliance requirements, and to generate the waypoint tokens based on the extracted current features of the space, the extracted geographical features of the space, and the extracted features regarding the compliance requirements.

4. The method of claim 1, wherein the trained vision-language-action model is a model trained to output action-type data for controlling the robot in response to receiving vision-type data and language-type data related to control of the robot.

5. The method of claim 4, wherein the vision-type data comprises the image of the space and the simplified map of the space that comprises the current position and the destination position of the robot,
the language-type data comprises the natural-language command specifying the compliance requirements that the robot is to comply with during the operation of the robot, and
the action-type data comprises a control command for controlling the operation of the robot in the space.

6. The method of claim 1, wherein the space comprises a first object that does not change position over time, a second object that does not change position during at least a portion of a time period of the operation of the robot, and a third object that continuously changes position over time, and
the simplified map reflects only a portion of the first object.

7. The method of claim 1, wherein the simplified map comprises the destination position of the robot that is defined by a user's input selected from drawing a destination point on the simplified map, drawing a route comprising the destination point on the simplified map, and drawing a line connecting a position of the robot and the destination point.

8. The method of claim 1, further comprising, after the generating of the waypoint tokens, controlling the robot based on the waypoint tokens.

9. The method of claim 8, wherein the controlling of the robot comprises controlling the robot by inputting the waypoint tokens to a robot controller, and
wherein the waypoint tokens comprise at least one waypoint defining a movement route of the robot with reference to at least one future time point, and each of the at least one waypoint comprises a direction feature indicating a direction toward a next waypoint and a distance feature reflecting a distance to the next waypoint.

10. A non-transitory computer-readable medium storing instructions that, when executed by one or more processors, cause a robot-control system to perform operations comprising:
acquiring an image of a space;
acquiring a simplified map of the space, the simplified map comprising a current position of a robot in the space and a destination position of the robot and not comprising at least some elements describing the space;
acquiring a natural-language command specifying compliance requirements that the robot is to comply with during an operation of the robot;
generating input tokens based on at least one of the image of the space, the simplified map, and the natural-language command; and
generating waypoint tokens by processing the input tokens with a trained vision-language-action model.
